(19) United States
(12) Patent Application Publication
(10) Pub. No.: US 2026/0138344 A1
(43) Pub. Date: May 21, 2026

(54) PANEL MEMBER PRESSURIZATION CONSTRUCTION DEVICE

(71) Applicant: USUN TECHNOLOGY CO., LTD., Taoyuan (TW)

(72) Inventor: Chiu-Fong HUANG, Taoyuan (TW)

(21) Appl. No.: 18/950,643

(22) Filed: Nov. 18, 2024

(51) Int. Cl. B30B 1/32; B30B 11/02

(52) U.S. Cl. CPC B30B 1/32; B30B 11/02

(57) ABSTRACT

A panel member pressurization construction device includes a set of processing units disposed in at least one working space of a working machine. The processing unit includes a processing space, a stopper and a pusher disposed in the processing space, a driving device for driving the pusher to reciprocate in the processing space. Multiple preset panel members can be placed inside the processing space to abut against the stopper, and then the driving device can be used to drive the pusher to push the preset panel members toward the stopper, so as to keep the preset panel members inside the processing space evenly stressed and pressed firmly, which can improve the product yield. It can pressurize multiple preset panel members at the same time, saving time and labor in the processing process, so as to achieve the purpose of processing and shaping of the preset panel members.

### BACKGROUND OF THE INVENTION

### 1. Field of the Invention

The present invention relates to a panel member pressurization construction device, in particular, it refers to a construction device that can perform average pressurization manufacturing of preset panel members, in which at least one set of processing units is set in at least one working space of the working machine to perform pressurization construction of at least two preset panel members, so as to achieve the purpose of stable processing and shaping of the preset panel members.

### 2. Description of the Related Art

In today's homes, commercial offices, and indoor partitions, most of them still use one-piece door panels, or have surface panels attached to both sides of the main body of the door panel to form a multi layered door panel. The space between the main body and the two lateral surface panels is filled with fillers to accelerate the combination of the main body and the two lateral surface panels, and the fillers are also used as sound insulation, heat insulation or warmth retention materials. With the different locations where the door panels are installed, such as building doors, living room doors, room doors, or kitchen and bathroom doors, there will be many changes in the shape and appearance of the door panels, and many colors and styles will be derived. The only thing that remains unchanged is that most of the door panels still have recessed or protruding reliefs or grooves on the surface to increase the beauty and novelty of the door panels to cater to consumers'preferences.

At present, in the manufacturing process of basic door panels, the surface panel is fixed to the main body by means of a jig, and the jig is supported on the surface of the surface panel to prevent damage when the filler is filled inside the main body. Generally, the jig and the surface panel are positioned by sticking or gluing with tape to secure the surface panel on the jig for subsequent processing. When the manufacturing process of the door panel is completed, the jig will be detached from the surface panel. Usually, one set of jigs can only produce one door panel at a time, and the processing process requires repeated disassembly and assembly of the jig and waiting for the filler to solidify and bond. In addition, during the filling process of the door panel, the filler will expand and foam inside the main body, so that the inner side of the surface panel will be squeezed outward by the filler. In addition, the concave or convex decorative designs on the surface of the door panel cause uneven pressurization inside the surface panel, which can easily cause expansion and deformation at the decorative design part of the surface panel, and lead to cracks or damage. This results in defective products being produced during the manufacturing process of the door panels, and also causes the related manufacturing process of the door panels to be quite time-consuming and labor-intensive.

Therefore, how to solve the above-mentioned troubles and difficulties in the current manufacturing of door panels, such as processing them one by one, which is time-consuming and labor-intensive, and the problems and defects of the fillers added inside the door panels during processing, such as uneven pressure, extrusion or deformation, are the key issues that the relevant manufacturers engaged in this industry are eager to study and improve.

### SUMMARY OF THE INVENTION

In view of the above-mentioned problems and deficiencies, the inventor collected relevant information, and after various evaluations and considerations, he designed this panel member pressurization construction device.

The main object of the present invention is that the panel member pressurization construction device is to set at least one set of processing units at at least one working space of a working machine. The at least one set of processing units comprises a processing space, a stopper and a pusher disposed on at least one side of the processing space, and at least one driving device for driving the pusher to reciprocate in the processing space. At least two preset panel members can be placed inside the processing space to abut against the stopper (if there is no preset panel member, filling it with an auxiliary panel member). Then, the driving device can be used to drive the pusher to push the preset panel members toward the stopper to keep the preset panel members in the processing space evenly stressed and pressed firmly, thereby improving the product yield. It can pressurize multiple preset panel members at the same time, and the processing process is more time-saving and labor-saving, so as to achieve the purpose of processing and shaping each preset panel member, and can provide the effect of stably combining and shaping each preset panel member.

Another object of the present invention is to provide at least one working space inside the working machine, and the at least one working space can be provided with an adjustable base, so that at least one set of processing units can be assembled and placed on the adjustable base, so that the length or width of the at least one working space can be adjusted by the adjustable base.

Still another object of the present invention is to assemble at least one set of processing units in at least one working space of the working machine; the processing unit comprises a holder base, the at least one driving device assembled on the holder base, the pusher driven by the at least one driving device and the stopper on the other side relative to the pusher, and the processing space is formed on the inner side of the pusher and the stopper; the working machine is provided with a power unit in at least one working space to limit and secure the holder base, and the power unit may be a motor, a hydraulic cylinder or a pneumatic cylinder, etc.

Still another object of the present invention is that the at least one processing space of at least one set of processing units comprises a plurality of partition grooves arranged adjacent to each other and at equal intervals, and at least one auxiliary mechanism is disposed above each partition groove; each auxiliary mechanism comprises a power unit, a first push member driven by the power unit to move toward each partition groove, a second push member pushed by the first push member, and a third push member pushed by the first push member and the second push member.

### BRIEF DESCRIPTION OF THE DRAWINGS

FIG. 1 is a top view of the present invention.

FIG. 2 is a front cross-sectional view of the present invention.

FIG. 3 is a side cross-sectional view of the material loading and unloading operation of the present invention.

FIG. 4 is a side cross-sectional view of the processing operation of the present invention (I).

FIG. 5 is a side cross-sectional view of the processing operation of the present invention (II).

FIG. 6 is a side cross-sectional view of the processing operation of the present invention (III).

FIG. 7 is a side cross-sectional view of the processing operation of the present invention (IV).

### DETAILED DESCRIPTION OF THE PREFERRED EMBODIMENT

In order to achieve the above objects and effect, the technical means and structure adopted in this invention, the drawing is hereby described in detail with respect to the preferred embodiment of this invention. Its features and functions are as follows for a complete understanding.

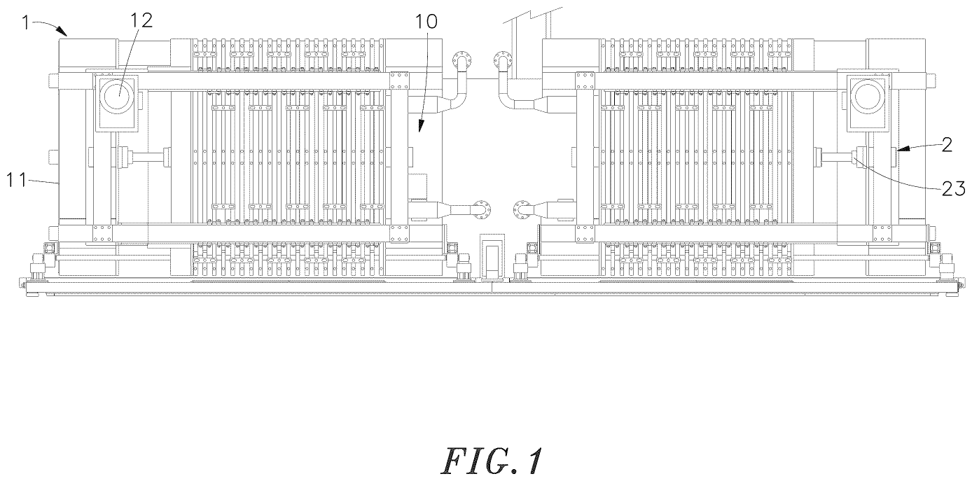

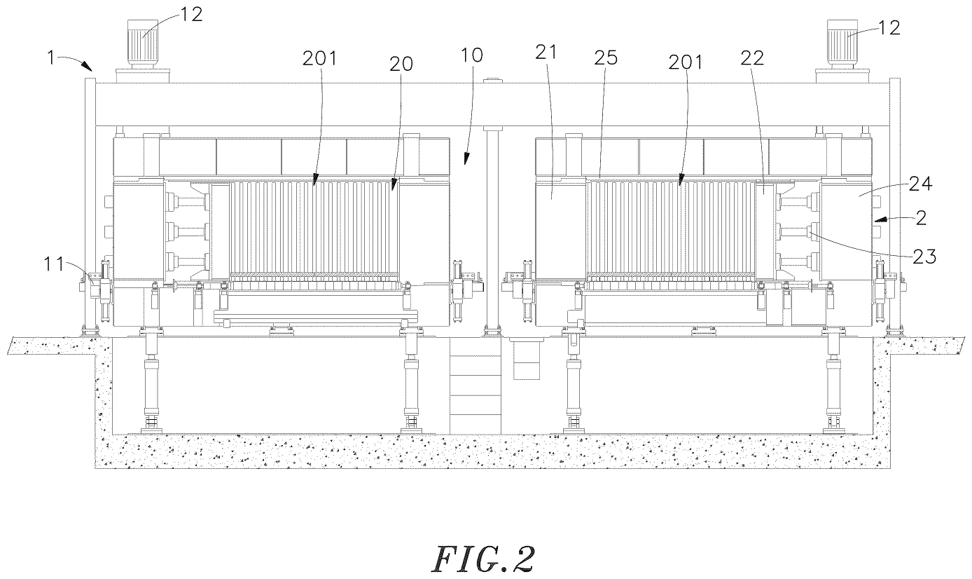

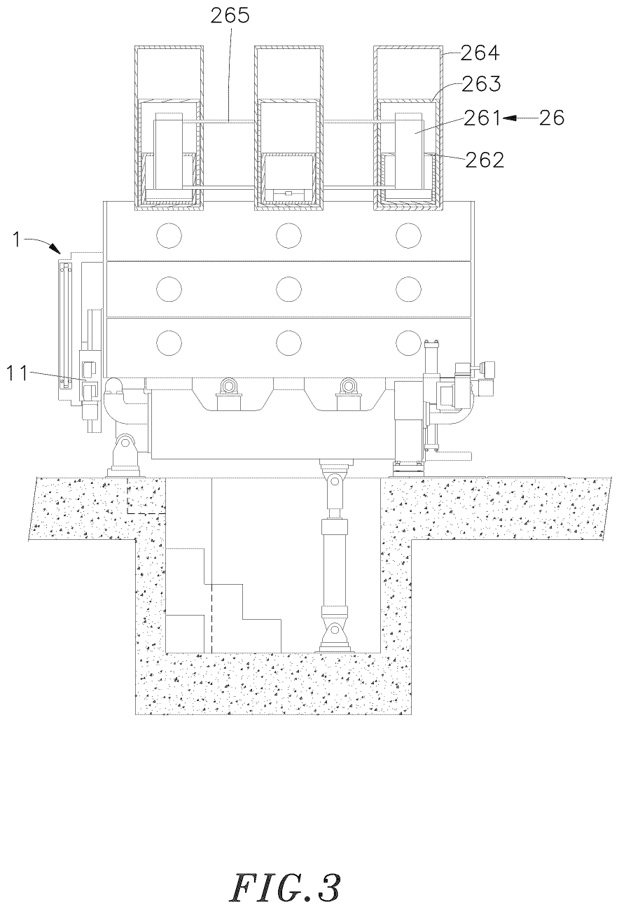

Please refer to FIGS. 1 to 7, the panel member pressurization construction device of the present invention comprises a working machine 1 and at least one set of processing units 2.

The working machine 1 comprises at least one working space 10.

The at least one set of processing units 2 is disposed in the at least one working space 10 of the working machine 1, and comprises a processing space 20, a stopper 21 and a pusher 22 disposed on at least one side of the processing space 20, and at least one driving device 23 for driving the pusher 22 to reciprocate in the processing space 20.

The above-mentioned working machine 1 of the present invention has at least one working space 10 inside. The at least one working space 10 may be provided with an adjustable base 11, which can be used to assemble and place at least one set of processing units 2 on the adjustable base 11, so as to accommodate preset panel members 3 of different sizes. The adjustable base 11 can be used to adjust the length or width of the at least one working space 10, such as the distance, space size, etc., so that the at least one working space 10 can accommodate the preset panel members 3 of different sizes.

The above-mentioned working machine 1 of the present invention has at least one working space 10 inside for assembling the at least one set of processing units 2. The processing unit 2 further comprises a holder base 24 and side stop blocks 25. The at least one driving device 23 is assembled on the holder base 24. The pusher 22 is driven by the at least one driving device 23. The stopper 21 is arranged on the holder base 24 at an opposite side relative to the pusher 22. The side stop blocks 25 are provided on the outer sides of the stopper 21 and the pusher 22. That is, the processing space 20 is formed at an inner side relative to the pusher 22, the stopper 21 and the side stop blocks 25. The working machine 1 is further provided with a power unit 12 at the at least one working space 10, which can be flexibly adjusted and can limit and tighten the holder base 24. The above-mentioned at least one driving device 23 and the power unit 12 can be a motor, a hydraulic cylinder or a pneumatic cylinder respectively.

The processing space 20 of the at least one set of processing units 2 comprises a plurality of adjacent and equally spaced partition grooves 201, and at least one auxiliary mechanism 26 is disposed above each partition groove 201. Each auxiliary mechanism 26 comprises a power unit 261, a first push member 262 driven by the power unit 261 to move toward each partition groove 201, a second push member 263 pushed by the first push member 262, and a third push member 264 pushed by the first push member 262 and the second push member 263.

In the preferred embodiment of the present invention, two auxiliary mechanisms 26 are respectively located at two opposite sides and one auxiliary mechanism 26 is located in the center between the two lateral auxiliary mechanisms 26, and the auxiliary mechanism 26 located in the center is connected to the power units 261 of the two auxiliary mechanisms 26 by driving connecting rods 265. That is, when the power units 261 on both sides actuate and drive the respective first push members 262, the respective second push members 263 and the respective third push members 264, the first push member 262, the second push member 263 and the third push member 264 of the auxiliary mechanism 26 in the center are actuated and displaced synchronously through the driving connecting rods 265. The power unit 261 of each of the above-mentioned auxiliary mechanisms 26 can be a power source such as a pneumatic cylinder, a hydraulic cylinder or a motor.

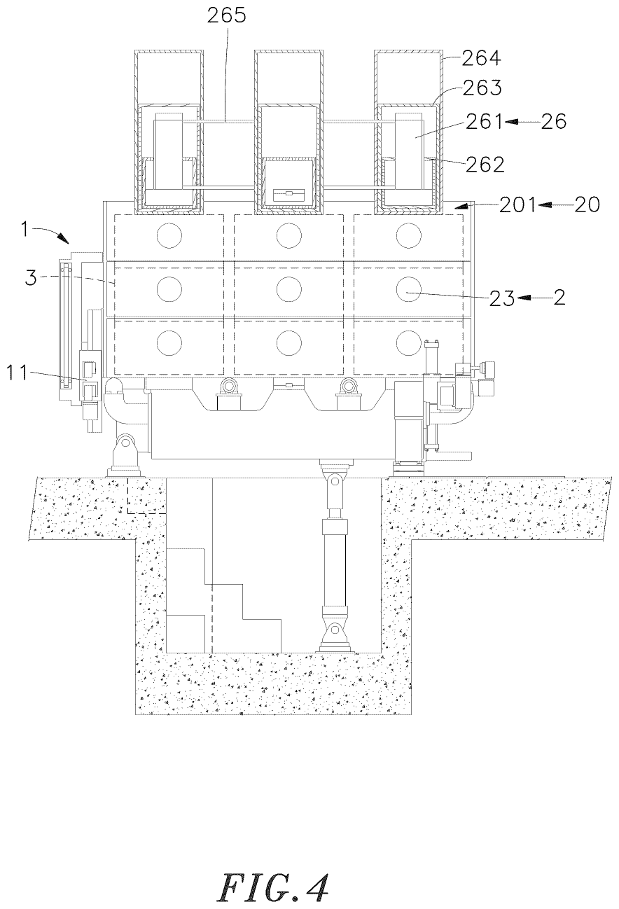

When the panel member pressurization construction device of the present invention is actually used, the preset panel members 3 (for example, various panel members such as door panels, interlayer panels or composite panels) can be respectively placed in the processing space 20 of the at least one set of processing units 2 in the at least one working space 10 of the working machine 1 according to the position of each partition groove 201. Then, according to the number of the preset panel members 3 accommodated in each partition groove 201, the limit position of the preset panel members 3 is adjusted through each auxiliary mechanism 26. Only three preset panel members 3 are placed in one of the partition grooves 201 (please also refer to FIG. 4, the number of the preset panel members 3 placed in each partition groove 201 can be adjusted according to the actual application implementation status. It can be one, two, three or more panels, etc., and the number of the preset panel members 3 placed in each partition groove 201 is not limited). The power unit 261 of the auxiliary mechanism 26 above can be used to drive the first push member 262 to drive the second push member 263 and the third push member 264 to press against the side of the adjacent preset panel member 3, so that the three preset panel members 3 are stably limited at the partition groove 201.

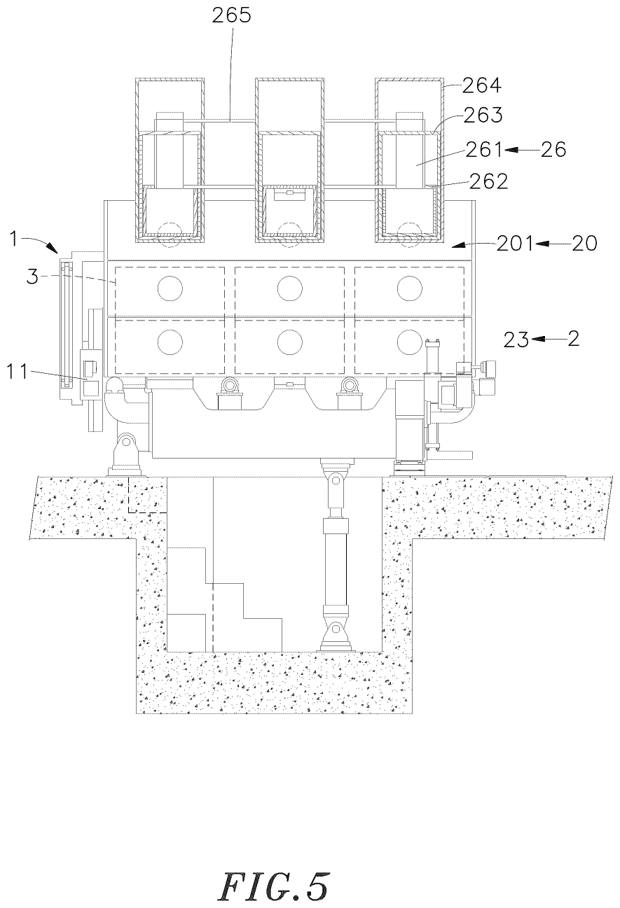

If only two preset panel members 3 are placed in one of the partition grooves 201 (please also refer to FIG. 5), the power unit 261 of the auxiliary mechanism 26 above can be used to drive the second push member 263 to drive the third push member 264 to press against the side of the adjacent preset panel member 3, so that the two preset panel members 3 are firmly limited at the partition groove 201.

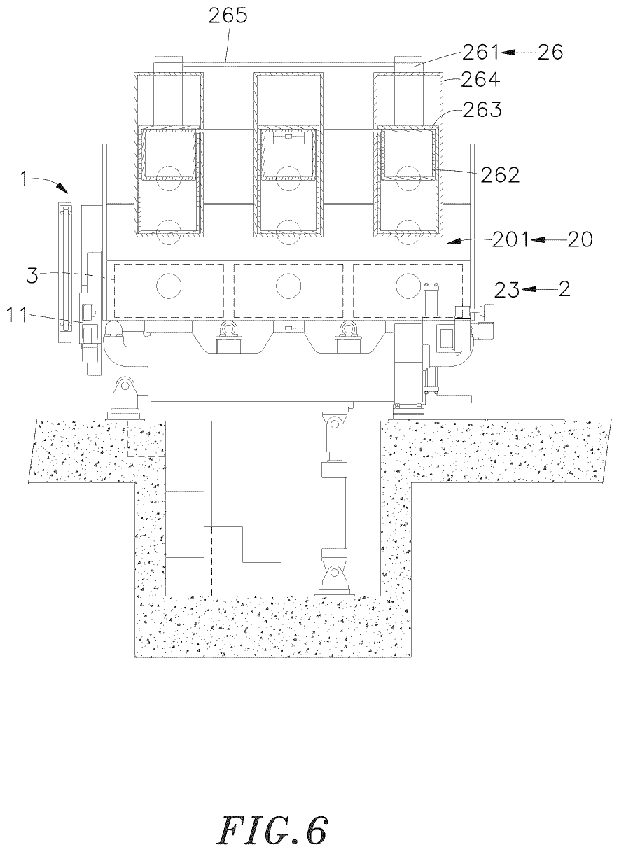

If only one preset panel member 3 is placed in one of the partition grooves 201 (please also refer to FIG. 6), the power unit 261 of the auxiliary mechanism 26 above can be used to drive the first push member 262 to drive the third push member 264 to press against the side of the adjacent preset panel member 3, so that the preset panel member 3 is stably limited at the partition groove 201.

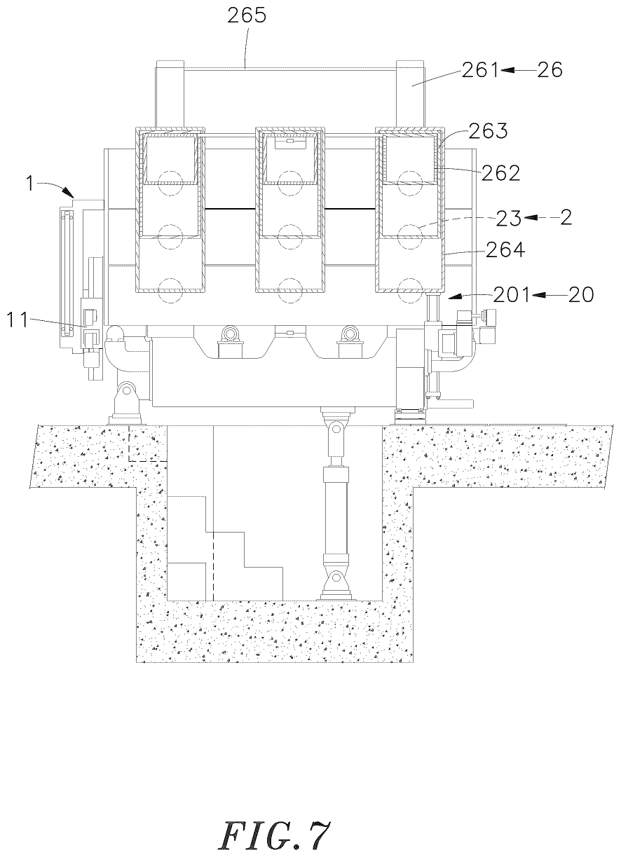

If no preset panel member 3 is placed in one of the partition grooves 201 (please also refer to FIG. 7), the power unit 261 of the auxiliary mechanism 26 above can be used to drive the third push member 264 to move to adjacent to the bottom of the partition groove 201 to fill the partition groove 201.

In the processing space 20 of the at least one set of processing units 2, the number of the preset panel members 3 placed in each partition groove 201 may be the same or different, and no preset panel member 3 may be placed in any one or more partition grooves 201, and the auxiliary mechanism 26 above each partition groove 201 is used to drive the first push member 262, the second push member 263 or the third push member 264 by the power unit 261 to fill the space inside each partition groove 201, and then, the driving device 23 of the at least one set of processing units 2 drives the pusher 22 to press each preset panel member 3 placed in each partition groove 201 in the processing space 20, and pushes and squeezes each preset panel member 3 toward the stopper 21, so that each preset panel member 3 can be evenly subjected to pressure, and internal filling materials (such as foaming agents, adhesives or limiting materials, etc.) can be stably stressed and evenly pressed and tightly combined, so the decorative design parts on the preset panel member 3 will not expand or deform to cause cracks or damage, etc., and the product yield in the manufacturing process of the preset panel member 3 can be improved, and the relevant processes of the preset panel member 3 can be more time-saving and labor-saving.

The above is only a preferred embodiment of the present invention, and does not limit the patent scope of the present invention. Therefore, all simple modifications and equivalent structural changes made by using the contents of the description and drawings of the present invention should be included in the patent scope of the present invention and should be declared.

In summary, the panel member pressurization construction device of the present invention has significant improvement in efficiency when used, and it sincerely meets the application requirements for an invention patent. I have filed an application in accordance with the law and hope that the review committee will approve this case as soon as possible to protect the inventor's hard work. If the review committee has any doubts, please feel free to send a letter for instructions. The inventor will do his best to cooperate. I really appreciate it.

What the invention claimed is:

1. A panel member pressurization construction device, comprising a working machine and at least one set of processing units, wherein:
said working machine comprises at least one working space;
said at least one set of processing units is respectively disposed in said at least one working space of said working machine, each said processing unit comprising a processing space, a stopper and a pusher disposed on at least one side of said processing space, at least one driving device for driving said pusher to reciprocate in said processing space, a plurality of partition grooves disposed in said processing space, and at least one auxiliary mechanism disposed above each of said partition grooves.

2. The panel member pressurization construction device as claimed in claim 1, wherein said at least one working space of said working machine is provided with an adjustable base for assembling and installing said at least one set of processing units, so that said adjustable base can be used to adjust the length or width of said at least one working space.

3. The panel member pressurization construction device as claimed in claim 1, wherein each said processing unit further comprises a holder base; said at least one driving device is assembled on said holder base; said pusher is assembled on said holder base and driven by said at least one driving device; said stopper is arranged on said holder base at an opposite side relative to said pusher, said processing space is formed at an inner side relative to said pusher and said stopper.

4. The panel member pressurization construction device as claimed in claim 3, wherein said working machine further comprises a power unit provided at said at least one working space to limit and tighten said holder base, said power unit being selectively a motor, a hydraulic cylinder, or a pneumatic cylinder.

5. The panel member pressurization construction device as claimed in claim 1, wherein each said auxiliary mechanism disposed above each said partition groove in said processing space of said at least one set of processing units comprises a power unit, a first push member driven by said power unit to move toward each said partition groove, a second push member pushed by each said first push member, and a third push member pushed by each said first push member and each said second push member.
